(19) United States
(12) Patent Application Publication
(10) Pub. No.: US 2004/0265551 A1
(43) Pub. Date: Dec. 30, 2004

(54) Electronic component and process for manufacturing the same

(75) Inventors: Minoru Takaya, Tokyo (JP); Toshikazu Endo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/829,299

(22) Filed: Apr. 22, 2004

(30) Foreign Application Priority Data
Apr. 23, 2003 (JP) P. 2003-118883
Feb. 12, 2004 (JP) P. 2004-035824

(51) Int. Cl. B32B 3/00; B44C 1/165; D04H 1/00; B32B 27/04; D04H 3/00; B32B 27/12; D04H 13/00; B32B 15/00; D04H 5/00

(52) U.S. Cl. 428/209; 442/394; 156/230; 156/233; 156/235; 428/901; 428/297.4

(57) ABSTRACT

A resinous material, or a composite material obtained by mixing a resin and a powdery functional material is formed into a thin sheet to make a core substrate 1. A patterned thin-film conductor 2 is formed by thin-film forming technology on at least either of the front and rear surfaces of the core substrate 1. Clothless layers 3a to 3d are super-posed on at least that surface of the core substrate 1 on which the thin-film conductor 2 has been formed. Each clothless layer is formed from a resin-coated metal foil obtained by coating one surface of a metal foil with a resinous material, or a composite material obtained by mixing a resin and a powdery functional material. Conductor layers 4a to 4d obtained by patterning the metal foils are formed on the clothless layers 3a to 3d.

### BACKGROUND OF THE INVENTION

This invention relates to an electronic component constructed as a laminated structure by using a resinous material, or a composite material obtained by mixing a resin and a powdery functional material, and to a process for manufacturing the same.

JP-A-5-267063 discloses a laminated electronic component having a thin-film conductor. It is made by superposing resin sheets not containing cloth or prepregs containing cloth on both surfaces of a core substrate having cloth to form a unitary body, forming a conductive layer on the resin sheets or prepregs with an insulating layer disposed therebetween and patterning it.

It is actually the case that it is impossible to make a core substrate having a thickness of 60 microns or less when a resin sheet not containing cloth is used therefor, as stated in JP-A-5-267063. The problem is, therefore, that a reduction in thickness and size of any electronic component is difficult, the use of any such electronic component limits any improvement in packaging density, and that an increase in the number of layers makes such difficulty particularly remarkable.

### SUMMARY OF THE INVENTION

In view of the above problem, this invention is aimed at providing an electronic component reduced in thickness and size, improved in packaging density and having an improved accuracy of patterning, as for an inductive element, and a process for manufacturing the same.

(1) The electronic component of this invention comprises: a cloth-containing core substrate made by forming a resinous material, or a composite material obtained by mixing a resin and a powdery functional material into a thin sheet; a thin-film conductor formed by thin-film forming technology on at least either of the front and rear surfaces of the core substrate, and patterned; a clothless layer superposed on at least that surface of the core substrate on which the thin-film conductor has been formed, and formed from a clothless resin-coated metal foil obtained by coating one surface of a metal foil with a resinous material, or a composite material obtained by mixing a resin and a powdery functional material, the metal foil being patterned.

(2) The electronic component of this invention is also characterized by having a plurality of such clothless layers superposed one upon another.

(3) The electronic component of this invention also comprises: a cloth-containing core substrate made by forming a resinous material, or a composite material obtained by mixing a resin and a powdery functional material into a thin sheet; a thin-film conductor formed by thin-film forming technology on at least either of the front and rear surfaces of the core substrate, and patterned; a clothless layer superposed on at least that surface of the core substrate on which the thin-film conductor has been formed, and formed from a clothless resin-coated metal foil obtained by coating one surface of a metal foil with a resinous material, or a composite material obtained by mixing a resin and a powdery functional material, the metal foil being patterned; the component being obtained by interposing a prepreg between a plurality of laminated products and/or between the laminated product and the core substrate having a thin-film conductor or the metal foil, laminating them and uniting them together by compression under heat.

(4) The electronic component of this invention is also characterized in that the core substrate and the thin-film conductor mainly constitute an inductive element, while the clothless layer and a conductor layer formed by the patterning of the metal foil mainly constitute a condenser and a wiring pattern.

(5) The electronic component of this invention is also characterized in that the resin comprises at least one kind of thermosetting resin selected from among an epoxy resin, a phenol resin, an unsaturated polyester resin, a vinyl ester resin, a polyimide resin, a bismaleimidetriazine (cyanate ester) resin, a polyphenylene ether (oxide) resin, a fumarate resin, a polybutadiene resin and a vinylbenzyl resin; or at least one kind of thermoplastic resin selected from among an aromatic polyester resin, a polyphenylene sulfide resin, a polyethylene terephthalate resin, a polybutylene tere- phthalate resin, a polyethylene sulfide resin, a polyether ether ketone resin, a polytetrafluoroethylene resin, a polyarylate resin and a graft resin; or a resin obtained by combining at least one kind of such thermosetting resin and at least one kind of such thermoplastic resin.

(6) The electronic component of this invention is also characterized in that the powdery functional material comprises at least one kind of ferrite magnetic material selected from among Mn—Mg—Zn, Ni—Zn and Mn—Zn; at least one kind of ferromagnetic metal material selected from among iron carbonyl, an iron-silicon alloy, an iron-aluminum-silicon alloy, an iron-nickel alloy and an amorphous (iron or cobalt) alloy; or at least one kind of dielectric material selected from among BaO—TiO₂—Nd₂O₃, BaO—TiO₂—SnO₂, PbO—CaO, TiO₂, BaTiO₃, PbTiO₃, SrTiO₃, CaTiO₃, Al₂O₃, BiTiO₄, MgTiO₃, (Ba, Sr)TiO₃, Ba(Ti, Zr)O₃, BaTiO₃—SiO₂, BaO—SiO₂, CaWO₄, Ba(Mg, Nb)O₃, Ba(Mg, Ta)O₃, Ba(Co, Mg, Nb)O₃, Ba(Co, Mg, Ta)O₃, Mg₂SiO₄, ZnTiO₃, SrZrO₃, ZrTiO₄, (Zr, Sn) TiO₄, BaO—TiO₂—Sm₂O₃, PbO—BaO—Nd₂O₃—TiO₂, (Bi₂O₃, PbO)— BaO—TiO₂, La₂Ti₂O₇, Nd₂Ti₂O₇, (Li, Sm)TiO₃, Ba(Zn, Ta)O₃, Ba(Zn, Nb)O₃ and Sr (Zn, Nb)O₃; or a functional material obtained by combining at least two kinds of materials selected from among the ferrite magnetic material, ferromagnetic metal material and dielectric material.

(7) The process of this invention for manufacturing an electronic component comprises: forming a resinous material, or a composite material obtained by mixing a resin and a powdery functional material into a thin sheet and curing it to make a core substrate; forming a thin-film conductor having a specific pattern by thin-film forming technology on at least either of the front and rear surfaces of the core substrate; superposing on the core substrate a clothless resin-coated metal foil obtained by coating one surface of a metal foil with a resinous material, or a composite material obtained by mixing a resin and a powdery functional material so that its clothless resin-coated surface may lie on at least that surface of the core substrate on which the thin-film conductor has been formed, and compressing them together under heat into a unitary body; patterning the metal foil to form a specifically shaped conductor layer.

(8) The process of this invention for manufacturing an electronic component is also characterized by repeating a number of times the step of superposing the clothless resin-coated metal foil on an existing layer and compressing them together under heat and the step of patterning the metal foil to form a specifically shaped conductor layer.

(9) The process of this invention for manufacturing an electronic component is also characterized by comprising: forming a resinous material, or a composite material obtained by mixing a resin and a powdery functional material into a thin sheet and curing it to make a core substrate; forming a thin-film conductor having a specific pattern by thin-film forming technology on at least either of the front and rear surfaces of the core substrate; superposing on the core substrate a clothless resin-coated metal foil obtained by coating one surface of a metal foil with a resinous material, or a composite material obtained by mixing a resin and a powdery functional material so that it may lie on at least that surface of the core substrate on which the thin-film conductor has been formed, and compressing them together under heat into a unitary body; patterning the metal foil to form a specifically shaped conductor layer; performing once the steps of compressing the clothless resin-coated metal foil into a unitary body and forming the conductor layer or repeating them two or more times to form a laminated product; interposing a prepreg between a plurality of laminated products and/or between any laminated product and the core substrate having a thin-film conductor or the metal foil, laminating them on one another and compressing them together into a unitary body.

This invention makes it possible to provide an electronic component reduced in thickness and size, improved in packaging density and having an improved accuracy of patterning, as for an inductive element, since the electronic component is made by using a thin-film conductor on a core substrate, superposing a clothless resin-coated metal foil thereon and patterning it.

### DETAILED DESCRIPTION OF THE DRAWINGS

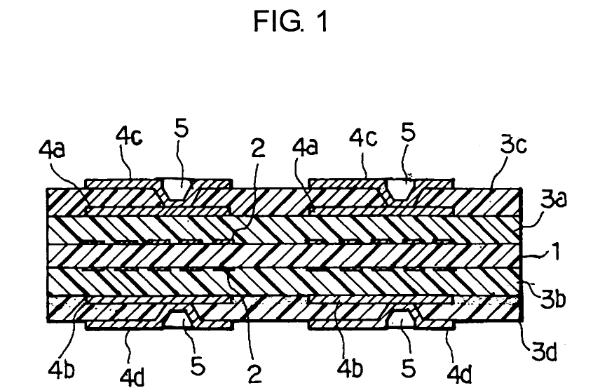

FIG. 1 is a sectional view showing one form of embodiment for an electronic component according to this invention.

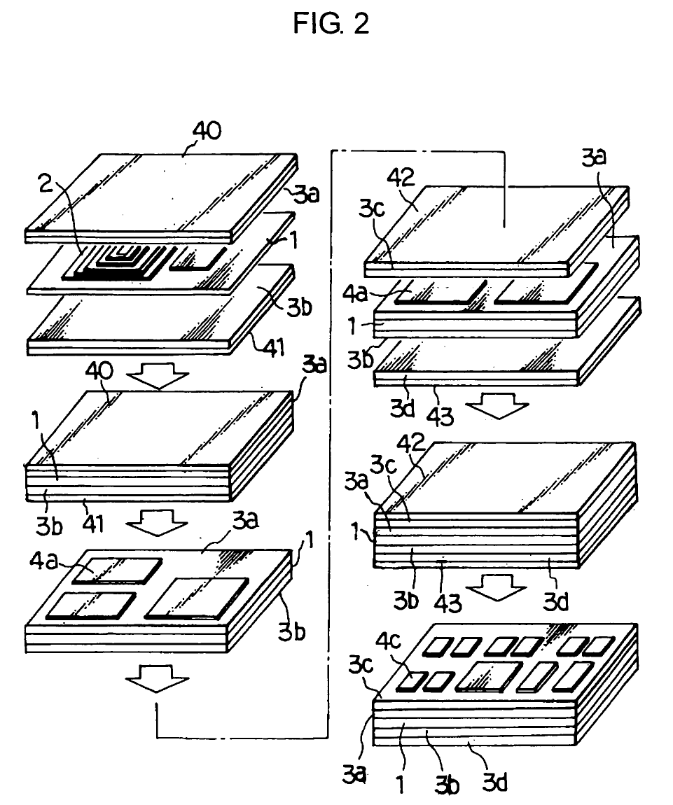

FIG. 2 is a flow chart showing one form of embodiment for a process for manufacturing the electronic component of FIG. 1.

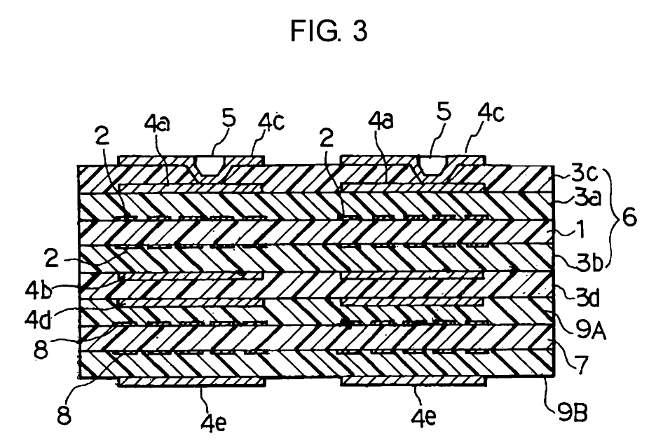

FIG. 3 is a sectional view showing another form of embodiment for an electronic component according to this invention.

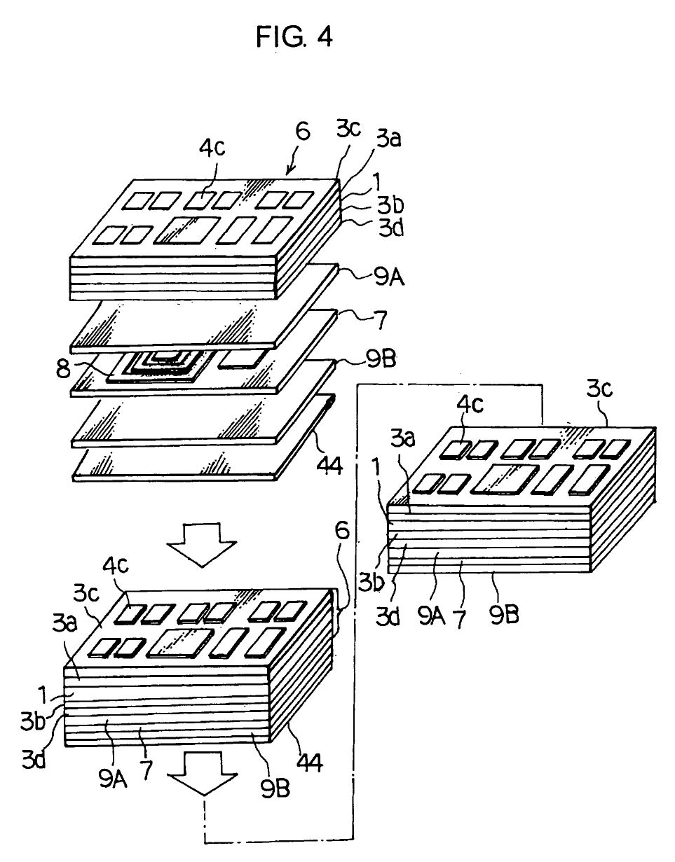

FIG. 4 is a flow chart showing one form of embodiment for a process for manufacturing the electronic component of FIG. 3.

### DETAILED DESCRIPTION OF THE PREFERRED EMBODIMENTS

FIG. 1 is a sectional view showing one mode of embodying an electronic component according to this invention. A core substrate 1 is made by a resinous material, or a composite material obtained by mixing a resin and a powdery functional material into a thin sheet, and containing cloth, such as glass cloth. A thermosetting resin is usually employed as the resin, though a thermoplastic resin can also be used. A thin-film conductor 2 is formed by thin-film forming technology on both surfaces of the core substrate 1. Vapor deposition, ionic plating, ion beam deposition, sputtering, vapor-phase growth, etc. may be used as thin-film forming technology. Copper, silver, nickel, tin, zinc, aluminum, etc. may be used as the thin-film conductor 2. The thin-film conductor 2 may alternatively be formed on only one side of the core substrate 1.

Clothless layers 3a to 3d are superposed on the core substrate 1 and compressed together under heat and the clothless layers are formed from a clothless resin-coated metal foil prepared by coating one surface of a metal foil with a resinous material, or a composite material obtained by mixing a resin and a powdery functional material. Conductor layers 4a to 4d are formed by the patterning of the metal foils. Although the same materials as for the thin-film conductors 2 may be used for the conductor layers 4a to 4d, copper, nickel and aluminum are, among others, preferred. Via holes 5 interconnects between the conductor layers 4a and 4c and between 4b and 4d.

FIG. 2 is a flow chart illustrating a process for manufacturing the electronic component of FIG. 1, and refers only to one component, though a large number of electronic components are actually manufactured by laminating the corresponding materials in sheet form, compressing them together and cutting them into the individual electronic components.

The core substrate 1 can be made as will now be explained. When a composite material is used for the core substrate 1, a resin, a functional powder (a powder of a magnetic or dielectric material) and a solvent, such as toluene, are kneaded into a paste. One or more kinds of resins as listed before may be used as the resin. One or more kinds of materials as listed before may be used as the powdery functional material to be mixed with the resin.

The preparation of a prepreg as a material for the core substrate 1 is made by applying a paste composed of a resinous or composite material and a solvent to glass cloth, passing the glass cloth through a dryer to remove the solvent for drying (semi-curing) and winding the material on a take-up reel. Then, it is cut in accordance with specific dimensions. The curing of a prepreg as prepared is, for example, carried out at 200° C. for two hours when a vinyl benzyl resin is used for a paste of a composite material.

The formation of the thin-film conductor 2 is done on at least either of the front and rear surfaces of the core substrate 1 by using thin-film forming technology, such as vapor deposition, ionic plating, ion beam deposition, sputtering or vapor-phase growth.

The patterning of the thin-film conductor 2 may, for example, be carried out by the steps of forming a resist on the core substrate 1 having the thin-film conductor formed on its whole surface, exposing to light for forming a conductor layer pattern, removing the resist partly, etching the thin film in the portion from which the resist has been removed, and removing the resist. As another method of patterning, a conductor thin-film pattern may be formed on the core substrate through a mask.

An inner via hole is formed in the core substrate 1, as required. In the step of forming an inner via-hole, a via-hole is made by a drill, punch or laser and its inner wall is plated with a conductor for connecting the thin-film conductors 2 on the front and rear surfaces of the core substrate 1. When the inner wall of the via-hole is plated with a conductor, the thin-film conductor 2 is appropriately masked, as by resist application, so that its thickness may not be increased. When a resist has been applied, it is removed after the via-hole has been plated.

The thin-film conductor 2 preferably has a thickness of 5 microns or less. If the thickness of the thin-film conductor 2 exceeds 5 microns, the formation of a thin film takes so long a time as to make a shortening of manufacturing time difficult, and if it is 5 microns or less, it is possible to avoid any prolongation of manufacturing time. If, on the other hand, the thickness of the thin-film conductor 2 is less than one micron, the resistance of the conductor is too high and if the maintenance of a certain level of Q is desired, the thickness of the thin-film conductor 2 is preferably one micron or more. The thickness of the thin-film conductor 2 may, however, be less than one micron in, for example, a condenser, or a circuit in which a large amount of loss is desired, such as a noise removing circuit, if it is 0.3 micron or more.

Metal foils 40 and 41 each having front and rear surfaces coated with crothless layers 3a and 3b are superposed on and beneath the core substrate 1 prepared as described above, so that the clothless layers 3a and 3b may face the core substrate 1, and the whole is compressed under heat. The resins listed before for the core substrate 1 may be used for the clothless layers 3a and 3b, or clothless layers 3c and 3d as will be referred to later, and when a composite material is desired, it is possible to use a mixture of a powder of a dielectric or magnetic material as listed before and a resin.

Then, the metal foils 40 and 41 are patterned to form patterns in conductor layers 4a and 4b, such as condensers and electrodes. Their patterning may be carried out by the steps of applying a resist to the metal foils 40 and 41, exposing the resist to light and removing it partly, etching those portions of the metal foils 40 and 41 from which the resist has been removed, and removing the resist.

Metal foils 42 and 43 having clothless layers 3c and 3d are superposed on the clothless layers 3a and 3b having the conductor layers 4a and 4b patterned as described, so that the clothless layers 3c and 3d may face the clothless layers 3a and 3b, respectively, and compression under heat and patterning are carried out as described above.

The holes 5 are formed as explained hereinafter. Those portions of the metal foils 42 and 43 in which via holes 5 are to be formed are removed by etching. Holes reaching the conductor layers 4a and 4b are made by a laser in the clothless layers 3c and 3d having their surfaces exposed by the removal of the metal foils. Then, electroless plating is done on the whole surfaces including the via holes 5 and is followed by electroplating. Then, patterns for the conductor layers 4c and 4d are formed by patterning in the same way as described before. It is possible that via holes may be formed in the clothless layers 3a and 3b, too, though not shown. The number of the clothless layers 3a to 3d may be increased or decreased, as required.

In the electronic component of this invention constituted as described, it is possible to obtain a product having a good pattern accuracy, a fine pattern, a large line length, a large number of turns and a high L value when the thin-film conductor 2 on the core substrate 1 mainly constitutes an inductive element (inductor, transformer, etc.). As the clothless layers 3a to 3d are formed by the clothless resin-coated metal foils, it is possible to obtain a product having a high capacity, since the layers can be formed with a small thickness in the order of, say, 50 microns or less (preferably 30 to 40 microns). This makes it possible to realize a reduction in thickness which contributes to a reduction in electrode area for a condenser having the same capacity. Moreover, a reduction in size of electronic components makes a high density of packaging possible. A further reduction in size and a higher density of packaging can be achieved by mixing a powder having a high dielectric constant in the resin.

FIG. 3 is a sectional view showing another mode of embodying the electronic component according to this invention and FIG. 4 is a chart showing a manufacturing process therefor. According to this mode of embodiment, an electronic component is obtained by preparing beforehand a core substrate 1, a laminated body 6 formed by clothless layers 3a to 3d, a core substrate 7 having patterns formed by thin-film conductors 8 different from, or equal to those described before and a metal foil 44, such as a copper foil, superposing them one upon another with prepregs 9A and 9B disposed therebetween, compressing them together under heat and patterning the metal foil 44 in the same way as described before. In FIG. 3, 4e denotes conductor layers obtained by the patterning of the metal foil 44.

The compression under heat with the prepregs 9A and 9B makes it possible to achieve a reduction in thickness and size and a higher density of packaging as stated before and moreover obtain a still more complicated electronic component having a larger number of elements. The simultaneous compression of a plurality of constituent elements under heat also makes it possible to achieve a reduction in thermal history, a reduction in time and labor required and a reduction in price and prevent any cracking and distortion, or any deterioration in properties as caused by the application of heat.

The simultaneous compression of materials under heat with prepregs is applicable to the simultaneous compression of the laminated bodies 6 under heat with prepregs and makes it possible to achieve a still further reduction in history, as well as a still further reduction in thickness and size.

When this invention is carried out, it is possible that through holes extending through the whole laminated assembly as shown in FIG. 1 or 3 may be made and subjected to electroless plating or electroplating to make a connection between the patterns on its front and rear surfaces and in its inside. The laminated assembly generally has terminal electrodes formed on its side by the plating and cutting of through holes, though not shown. It is also possible that a semiconductor device, a high capacity condenser, a resistance, an inductor, etc. may be mounted on the surface of the laminated assembly.

This invention can be realized as condensers, inductors, or various kinds of modules obtained by the combination (or hybrid integration) of LC filters, LCR filters or semiconductor components and passive components (circuits), such as voltage-controlled oscillators.

What is claimed is:

1. An electronic component comprising:
a cloth-containing core substrate made by forming a resinous material, or a composite material obtained by mixing a resin and a powdery functional material into a thin sheet;
a thin-film conductor formed and patterned by thin-film forming technology on at least either of front and rear surfaces of the core substrate;
a clothless layer superposed on at least that surface of the core substrate on which the thin-film conductor has been formed, and formed from a clothless resin-coated metal foil obtained by coating one surface of a metal foil with a resinous material, or a composite material obtained by mixing a resin and a powdery functional material, the metal foil being patterned.

2. The electronic component as set forth in claim 1, wherein the clothless layer is formed by placing a plurality of such clothless layers one upon another.

3. An electronic component including a laminated product comprising:
a cloth-containing core substrate made by forming a resinous material, or a composite material obtained by mixing a resin and a powdery functional material into a thin sheet;
a thin-film conductor formed and patterned by thin-film forming technology on at least either of the front and rear surfaces of the core substrate;
a clothless layer superposed on at least that surface of the core substrate on which the thin-film conductor has been formed, and formed from a clothless resin-coated metal foil obtained by coating one surface of a metal foil with a resinous material, or a composite material obtained by mixing a resin and a powdery functional material, the metal foil being patterned;
the component being obtained by interposing a prepreg between a plurality of laminated products and/or between the laminated product and the core substrate having a thin-film conductor or the metal foil, laminating them and uniting them together by compression under heat.

4. The electronic component as set forth claim 1, wherein the core substrate and the thin-film conductor mainly constitute an inductive element, and the clothless layer and a conductor layer formed by the patterning of the metal foil mainly constitute a condenser and a wiring pattern.

5. The electronic component as set forth claim 3, wherein the core substrate and the thin-film conductor mainly constitute an inductive element, and the clothless layer and a conductor layer formed by the patterning of the metal foil mainly constitute a condenser and a wiring pattern.

6. The electronic component as set forth in claim 1, wherein the resin comprises at least one kind of thermosetting resin selected from among an epoxy resin, a phenol resin, an unsaturated polyester resin, a vinyl ester resin, a polyimide resin, a bismaleimidetriazine (cyanate ester) resin, a polyphenylene ether (oxide) resin, a fumarate resin, a polybutadiene resin and a vinylbenzyl resin; or at least one kind of thermoplastic resin selected from among an aromatic polyester resin, a polyphenylene sulfide resin, a polyethylene terephthalate resin, a polybutylene tere- phthalate resin, a polyethylene sulfide resin, a polyether ether ketone resin, a polytetrafluoroethylene resin, a polyarylate resin and a graft resin; or a resin obtained by combining at least one kind of such thermosetting resin and at least one kind of such thermoplastic resin.

7. The electronic component as set forth in claim 3, wherein the resin comprises at least one kind of thermosetting resin selected from among an epoxy resin, a phenol resin, an unsaturated polyester resin, a vinyl ester resin, a polyimide resin, a bismaleimidetriazine (cyanate ester) resin, a polyphenylene ether (oxide) resin, a fumarate resin, a polybutadiene resin and a vinylbenzyl resin; or at least one kind of thermoplastic resin selected from among an aromatic polyester resin, a polyphenylene sulfide resin, a polyethylene terephthalate resin, a polybutylene tere- phthalate resin, a polyethylene sulfide resin, a polyether ether ketone resin, a polytetrafluoroethylene resin, a polyarylate resin and a graft resin; or a resin obtained by combining at least one kind of such thermosetting resin and at least one kind of such thermoplastic resin.

8. The electronic component as set forth claim 1, wherein the powdery functional material comprises at least one kind of ferrite magnetic material selected from among Mn—Mg—Zn, Ni—Zn and Mn—Zn; at least one kind of ferromagnetic metal material selected from among iron carbonyl, an iron-silicon alloy, an iron-aluminum-silicon alloy, an iron-nickel alloy and an amorphous (iron or cobalt) alloy; or at least one kind of dielectric material selected from among BaO—TiO₂—Nd₂O₃, BaO—TiO₂—SnO₂, PbO—CaO, TiO₂, BaTiO₃, PbTiO₃, SrTiO₃, CaTiO₃, Al₂O₃, BiTiO₄, MgTiO₃, (Ba, Sr)TiO₃, Ba(Ti, Zr)O₃, BaTiO₃—SiO₂, BaO—SiO₂, CaWO₄, Ba(Mg, Nb)O₃, Ba(Mg, Ta)O₃, Ba(Co, Mg, Nb)O₃, Ba(Co, Mg, Ta)O₃, Mg₂SiO₄, ZnTiO₃, SrZrO₃, ZrTiO₄, (Zr, Sn)TiO₄, BaO—TiO₂—Sm₂O₃, PbO—BaO—Nd₂O₃—TiO₂, (Bi₂O₃, PbO)— BaO—TiO₂, La₂Ti₂O₇, Nd₂Ti₂O₇, (Li, Sm)TiO₃, Ba(Zn, Ta)O₃, Ba(Zn, Nb)O₃ and Sr(Zn, Nb)O₃; or a functional material obtained by combining at least two kinds of materials selected from among the ferrite magnetic material, ferromagnetic metal material and dielectric material.

9. The electronic component as set forth claim 3, wherein the powdery functional material comprises at least one kind of ferrite magnetic material selected from among Mn—Mg—Zn, Ni—Zn and Mn—Zn; at least one kind of ferromagnetic metal material selected from among iron carbonyl, an iron-silicon alloy, an iron-aluminum-silicon alloy, an iron-nickel alloy and an amorphous (iron or cobalt) alloy; or at least one kind of dielectric material selected from among BaO—TiO₂—Nd₂O₃, BaO—TiO₂—SnO₂, PbO—CaO, TiO₂, BaTiO₃, PbTiO₃, SrTiO₃, CaTiO₃, Al₂O₃, BiTiO₄, MgTiO₃, (Ba, Sr)TiO₃, Ba(Ti, Zr)O₃, BaTiO₃—SiO₂, BaO—SiO₂, CaWO₄, Ba(Mg, Nb)O₃, Ba(Mg, Ta)O₃, Ba(Co, Mg, Nb)O₃, Ba(Co, Mg, Ta)O₃, Mg₂SiO₄, ZnTiO₃, SrZrO₃, ZrTiO₄, (Zr, Sn)TiO₄, BaO—TiO₂—Sm₂O₃, PbO—BaO—Nd₂O₃—TiO₂, (Bi₂O₃, PbO)— BaO—TiO₂, La₂Ti₂O₇, Nd₂Ti₂O₇, (Li, Sm)TiO₃, Ba(Zn, Ta)O₃, Ba(Zn, Nb)O₃ and Sr(Zn, Nb)O₃; or a functional material obtained by combining at least two kinds of materials selected from among the ferrite magnetic material, ferromagnetic metal material and dielectric material.

10. A process for manufacturing an electronic component comprising:
forming a resinous material, or a composite material obtained by mixing a resin and a powdery functional material into a thin sheet and curing it to make a core substrate;
forming a thin-film conductor having a specific pattern by thin-film forming technology on at least either of the front and rear surfaces of the core substrate;
superposing on the core substrate a clothless resin-coated metal foil obtained by coating one surface of a metal foil with a resinous material, or a composite material obtained by mixing a resin and a powdery functional material so that its clothless resin-coated surface may lie on at least that surface of the core substrate on which the thin-film conductor has been formed, and compressing them together under heat into a unitary body;
patterning the metal foil to form a specifically shaped conductor layer.

11. The process for manufacturing an electronic component as set forth in claim 10, wherein the step of superposing the clothless resin-coated metal foil on an existing layer and compressing them together under heat and the step of patterning the metal foil to form a specifically shaped conductor layer are repeated a specific number of times.

12. A process for manufacturing an electronic component comprising:
forming a resinous material, or a composite material obtained by mixing a resin and a powdery functional material into a thin sheet and curing it to make a core substrate;
forming a thin-film conductor having a specific pattern by thin-film forming technology on at least either of the front and rear surfaces of the core substrate;
superposing on the core substrate a clothless resin-coated metal foil obtained by coating one surface of a metal foil with a resinous material, or a composite material obtained by mixing a resin and a powdery functional material so that it may lie on at least that surface of the core substrate on which the thin-film conductor has been formed, and compressing them together under heat into a unitary body;
patterning the metal foil to form a specifically shaped conductor layer;
performing once the steps of compressing the clothless resin-coated metal foil into a unitary body and forming the conductor layer or repeating them two or more times to form a laminated product;
interposing a prepreg between a plurality of laminated products and/or between any laminated product and the core substrate having a thin-film conductor or the metal foil, laminating them on one another and compressing them together into a unitary body.
